(19) United States
(12) Patent Application Publication
(10) Pub. No.: US 2008/0318037 A1
(43) Pub. Date: Dec. 25, 2008

(54) Laminate Comprising at Least One Polyether Block Copolymer Substrate, Manufacturing Process and Use in the Shoe Industry

(76) Inventors: Jean-Luc Maral, Yvetot (FR); Bruno Dherbecourt, Bernay (FR)

Correspondence Address: ARKEMA INC.;PATENT DEPARTMENT - 26TH FLOOR, 2000 MARKET STREET, PHILADELPHIA, PA, 19103-3222, US

(21) Appl. No.: 12/161,636

(22) PCT Filed: Jan. 19, 2007
(86) PCT No.: PCT/FR07/50665

§ 371 Date: Jul. 21, 2008

(30) Foreign Application Priority Data
Jan. 20, 2006 (FR) 0600515

(51) Int. Cl. B32B 7/12; B32B 27/40; B32B 38/16

(52) U.S. Cl. 428/339; 428/423.1; 156/281

(57) ABSTRACT

The present invention relates to a laminated product comprising a first and a second substrate that adhere to each other only by means of a cured and crosslinked layer of a polymeric adhesive containing no organic solvent, characterized in that: a) the polymeric material of either or both of the first or second substrates is a polyether block copolymer; and b) the polymeric adhesive is a moisture-crosslinkable hot-melt adhesive based on a polyurethane prepolymer or on a blend of polyurethane prepolymers containing free isocyanate (—N═C═O) functional groups. The present invention also relates to a process for manufacturing such a laminate and to its use in the shoe industry, especially for the manufacture of soles and most particularly sports shoe soles.

The present invention relates in general to a laminated product comprising at least one substrate made of a polyether block copolymer, in particular a copolymer having polyether blocks and polyamide blocks (PEBA), that adheres to another substrate, of the same or different nature, solely by means of a cured and crosslinked layer of an adhesive containing no organic solvent.

The present invention also relates to a process for manufacturing such a laminate and to its use in the shoe industry, especially for the manufacture of soles and most particularly to sports shoe soles.

One of the main fields of expertise in the shoe industry is good control of the bonding techniques intended for joining materials of different chemical nature and mechanical properties together. This know-how is particularly important in the field of sports shoes in which the materials used, especially for manufacturing the soles, are frequently new. This requirement is compounded by the search for the performance generally associated with sports shoes.

Over the last ten years, materials based on PEBA copolymers, such as the materials sold by Arkema under the brand name Pebax®, have become progressively introduced into the field of top-of-the-range shoes, particularly sports shoes, thanks to their mechanical properties and especially their exceptional spring-back property.

Substrates made from these PEBA copolymer materials, especially for the manufacture of sports shoe soles, are generally assembled by bonding them to other substrates by means of adhesive systems of the bicomponent polyurethane type.

In general, the bonding of this type of substrate in order to produce a laminate requires the following operations:
the surfaces of the substrates to be bonded are cleaned with an organic solvent, such as methyl ethyl ketone (MEK);
a layer of a generally solvent-based primer composition is applied, generally by means of a brush, to at least the contacting surface of the PEBA copolymer substrate;
the primer layer is dried in an oven;
a layer of bicomponent adhesive is applied, generally using a brush, to the primer layer and also to the contacting surface of the other substrate;
the adhesive layers are dried in an oven;
the two adhesive-coated substrates are brought into contact with each other; and
the assembly resulting from the contacting undergoes a pressing operation.

The primer compositions used are generally bicomponent compositions, the first component of which is a solution of a polyester resin in an organic solvent and the second (crosslinking) component, which is added to the first component just before use, is an isocyanate or blend of isocyanates, also dissolved in an organic solvent.

Bicomponent adhesives comprise a first component, which is a hydroxylated organic resin dispersed or dissolved in an organic solvent and/or in water and a second (crosslinking) component, which is either at least one isocyanate or a solution of at least one isocyanate in an organic solvent.

During the drying operations, both the primer compositions and the adhesives of the prior art result in the evaporation of a large amount of organic solvent. Thus, in the case of the manufacture of a laminate for a shoe, it is estimated that the average amount of adhesive used is 5 g and that of primer composition is 3 g for a shoe, and the amount of solvent emitted per shoe can be estimated to be 2.9 g. Taking a production of 10 000 shoes per day for a production unit, the total amount of solvent emitted by this unit is 29 kg per day.

Moreover, the quality of the bonding of the systems of the prior art (expressed by the peel force for peeling the substrates) is far from optimal. Thus, although peel forces of around 6 to 6.5 daN/cm are obtained with substrates made of a PEBA copolymer of low to moderate hardness (for example Pebax® 55-1), a peel force of no more than about 3 daN/cm is obtained with substrates made of a PEBA copolymer of high hardness (for example Pebax® 70-1). Now, shoe manufacturers impose a peel strength of at least 3 daN/cm. It is therefore found that the bonding with the systems of the prior art is barely sufficient in the case of the hardest PEBA copolymers.

Finally, the use of bicomponent compositions is expensive in terms of raw materials, as once the components have been blended together, the compound formed must be rapidly used and cannot be stored for the purpose of future use.

The object of the present invention is therefore to provide a laminate comprising at least one substrate made of a PEBA copolymer and a process for manufacturing such a laminate which remedy the drawbacks of the prior art.

In particular, the object of the present invention is to provide such a laminate whose peel strength remains high even when substrates made of PEBA copolymer of high hardness are used and the manufacturing process of which avoids substantial solvent evolution.

The object of the present invention is, in addition, to provide such a laminate, which contains no primer layer.

It has now been found, according to the invention, that the above objectives may be achieved using only one layer of a one-component adhesive polymer material, which is a moisture-crosslinkable hot-melt material comprising at least one polyurethane prepolymer containing at least one free isocyanate functional group in order to bond a PEBA copolymer substrate to another substrate.

However, it would not be outside the scope of the invention if the same prepolymers were to be used with blocked isocyanate groups that are unblocked at the moment of use of the hot-melt adhesive.

More particularly, the laminated product according to the invention comprises a first substrate and a second substrate that adhere to each other only by means of a cured and crosslinked layer of an adhesive polymer material containing no organic solvent of any type, characterized in that:
(a) the polymer material of either or both of the first and second substrates is a polyether block copolymer, preferably a PEBA; and
(b) the adhesive polymer material is a moisture-crosslinkable hot-melt adhesive based on at least one polyurethane prepolymer containing free isocyanate (—N═C═O) functional groups or on a blend of at least one polyurethane prepolymer containing free isocyanate (—N═C═O) functional groups.

In general, the content of free isocyanate functional groups of the polyurethane prepolymer represents 0.5 to 25% by weight, preferably 2 to 10% by weight, relative to the total weight of the prepolymer.

In general, the polyurethane prepolymers suitable for the present invention have a number-average molecular weight Mₙ of 500 to 500 000, preferably 1000 to 300 000 and better still 5000 to 150 000, determined by gel permeation chromatography.

The polyurethane prepolymer or prepolymers represent in general, by weight, 75% or more, preferably 90% or more and better still 95% or more of the adhesive polymer material.

The polyurethane prepolymers of the moisture-crosslinkable hot-melt adhesives suitable for the present invention are conventionally the products resulting from the reaction of at least one hydroxylated reactant, chosen from (i) hydroxylated polyesters, (ii) hydroxylated polyethers and combinations thereof, with at least one polyisocyanate, preferable a diisocyanate.
The hydroxylated polyesters may be amorphous or crystalline. Crystalline and amorphous hydroxylated polyesters are solids at room temperature, with melting points ranging from 40° C. to 160° C.

These hydroxylated polyesters have number-average molecular weights Mₙ that vary from 1000 to 21 000 and are commercially available, for example from Bayer under the name Rucoflex® or from Baxenden under the name Xenol DP®.

Among hydroxylated polyesters, mention may also be made of hydroxylated polyesters derived from lactones and from polyols, especially those derived from a caprolactone such as ε-caprolactone and from an alkanediol, such as butanediol. These hydroxylated polyesters have number-average molecular weights Mₙ that vary from 200 to 3000. They are also commercially available from Solvay under the name Capa®.

These hydroxylated polyesters generally have a hydroxyl number that may range from 5 to 300, preferably 10 to 300, and contain at least two hydroxyl groups per molecule.
The hydroxylated polyethers suitable for the invention are generally poly(oxyalkylenes) having a number-average molecular weight of 250 to 5000.

Among preferred hydroxylated polyethers, mention may be made of polyethylene glycols (with a number-average molecular weight of 250-4000), polypropylene glycols (having a number-average molecular weight of 250-5000) and polytetramethylene glycols (PTMG, with a number-average molecular weight of 250-2500, preferably 600-2500).

Preferably, blends of hydroxylated polyethers, hydroxylated polyesters or hydroxylated polyesters and hydroxylated polyethers are used.

The polyisocyanates are preferably diisocyanates. Among preferred diisocyanates, mention may be made of 4,4′-diphenylmethane diisocyanate (MDI), 1,6-hexamethylene diisocyanate (HDI), isophorone diisocyanate (IPDI) and toluene diisocyanate (TDI). Preferably MDI or a mixture of MDI with one or more of HDI, IPDI and TDI is used.

In general, the polyurethane prepolymer is the product resulting from the reaction of 55 to 95%, preferably 65 to 85%, by weight of hydroxylated polyesters and/or hydroxylated polyethers with 45 to 5%, preferably 35 to 15%, by weight of at least one polyisocyanate.

The reaction mixture for obtaining the polyurethane prepolymer may also contain one or more conventional crosslinking catalysts, such as dibutyl tin dilaurate (DBTDL) or dibutyl tin dilauryl sulphide, in an amount of 0 to 4%, preferably 0.01 to 0.1%, by weight relative to the total weight of the material.

The adhesive polymer material may also contain conventional additives, in standard proportions, such as:
stabilizers, such as benzoyl chloride, phosphoric acid, acetic acid, p-toluenesulfonyl isocyanate,
fillers,
tackifiers, such as
terpene resins, dicyclopentadiene derivatives, alpha-pinene and beta-pinene, dipentene, natural or esterified or modified colophony, possibly modified with phenolic resins,
copolymers resulting from the reaction:
(i) of an ethylene/unsaturated epoxide copolymer containing 60 to 90% ethylene by weight, said unsaturated epoxide being grafted or copolymerized and able to be either an ethylene/glycidyl (meth)acrylate copolymer or an ethylene/alkyl (meth)acrylate/glycidyl (meth)acrylate copolymer; with
(ii) a carboxylic acid of formula R1-COOH or derivatives thereof, in which R1 denotes an alkyl, cycloalkyl or aromatic radical comprising at least one hydroxyl function (40 to 200 meq of OH function), in particular dimethylolpropionic acid (abbreviated to DMPA), and also
polyolefines, such as:
   copolymers: ethylene/vinyl acetate (for example EVATANE®) ethylene/alkyl(meth)acrylate (for example LOTRYL®) such as ethylene/methyl acrylate, ethylene/methyl methacrylate, ethylene/ethyl acrylate, ethylene/butyl acrylate and ethylene/2-ethylhexyl acrylate,
   terpolymers: ethylene/vinyl acetate/maleic anhydride (for example OREVAC®T), ethylene/acrylic ester/maleic anhydride (for example LOTADER®MAH), ethylene/acrylic ester/glycidyl methacrylate (for example LOTADER®GMA),
   grafted polyolefins: MAH-grafted LDPE, MAH-grafted LLDPE, MAH-grafted HDPE, MAH-grafted PP, MAH-grafted ethylene/vinyl acetate or MAH-grafted ethylene/alkyl (meth)acrylate, such as MAH-grafted ethylene/methyl acrylate (for example OREVAC®G),
particularly preferably, terpolymers having reactive groups of the maleic anhydride (abbreviated MAH) type or of the glycidyl methacrylate (abbreviated GMA) type, and grafted polyolefins having reactive groups of the maleic anhydride (abbreviated MAH) type, in particular those defined above.
The role of these agents is to promote the adhesion to the substrate in the first phase of the bonding by means of their physical adhesivity property. This is because the limit of hot-melt adhesives lies in their low capacity to keep the assembled parts together just after leaving the cooling/shaping unit. Because the polymer network has not yet formed, the adhesive has a very low mechanical performance and is incapable of keeping the assembled parts together if the assembly induces a stress owing to its elasticity, its weight (even if low) or any shape-memory effect. To obtain, upon cooling, a certain mechanical strength, polymers of the polyolefin type are introduced into the adhesive polymer material, which polyolefins will increase the peel strength immediately after assembly,
UV stabilizers, such as benzotriazol derivatives,
surfactants,
pigments,
viscosity modifiers,
UV tracers, such as bis(benzoazolyl) derivatives, and
antioxidants, such as thiopropionate derivatives.

In general, the tackifiers represent from 0 to 20%, preferably from 0 to 5%, the UV tracers represent from 0 to 0.1% and the antioxidants represent from 0 to 2% by weight of the adhesive polymer material.

Tables I, II and III below give the components and their proportions relative to adhesive polymer materials according to the invention.

TABLE I

| | % by weight |
|---|---|
| | relative to the |
| | total weight of |
| STANDARD ADHESIVE POLYMER MATERIAL | the material |
| Hydroxylated polymers | 55-95 |
| linear hydroxylated polyester (1000 to | 0-60 |
| 21 000 molecular weight Mₙ) | |
| hydroxylated polyester derived from | 0-50 |
| caprolactone (Mₙ: 200-3000) | |
| crystalline hydroxylated polyester | 0-30 |
| amorphous hydroxylated polyester | 0-50 |
| polypropylene glycol (Mₙ: 250 to 5000) | 0-65 |
| polytetramethylene glycol (Mₙ: | 0-60 |
| 250-2500) | |
| polyethylene glycol (Mₙ: 250-4000) | 0-60 |
| Polyisocyanates | 5-45 |
| MDI | 5-45 |
| HDI | 0-40 |
| IPDI | 0-20 |
| TDI | 0-30 |
| Catalysts | 0-0.4 |
| Additives | 0-10 |
| tackifiers | 0-5 |
| UV stabilizers | 0-0.5 |
| UV tracers | 0-0.1 |
| antioxidants | 0-2 |

TABLE II

| | % by weight |
|---|---|
| | relative to the |
| ADHESIVE POLYMER MATERIAL A | total weight of |
| Components | the material |
| blend of hydroxylated polyesters¹ | 84 |
| MDI | 14 |
| antioxidant² and UV stabilizer³ | 2 |

¹57% Capa 2200 ® (Mₙ = 2000) + 35% Dynapol ® LS615 (Mₙ = 4000) + 8% Xenol DP ® 9B/1381 (Mₙ = 2000)

TABLE III

| | % by weight |
|---|---|
| ADHESIVE POLYMER MATERIALS | relative to the |
| B4a, B4b, B4b′ and B4c | total weight of |
| Components | the material |
| blend of hydroxylated polyesters⁴ | 66 |
| MDI | 32 |
| antioxidant² and UV stabilizer³ | 2 |

²Irganox ® 245 (triethylene glycol bis-3-(3-tert-butyl-4-hydroxy-5-methylphenyl)propionate + Cyagard A0-LTDP ® (dilauryl thiodipropionate)
³benzotriazol
⁴Four different blends of hydroxylated polyesters are envisaged (%) by weight of said blend):

Blend 4a giving the adhesive material B4a:

| | |
|---|---|
| Capa 2043 ® (Mₙ = 400) | 48.2 |
| Rucoflex XS ® - 6012 P-22 (Mₙ = 5000) | 43 |
| Xenol DP ® 9B/1339 (Mₙ = 3500) | 8.8 |

Blend 4b giving the adhesive material B4b:

| | |
|---|---|
| Capa 2077 ® (Mₙ = 750) | 45 |
| Rucoflex XS ® - 6012 P-22 (Mₙ = 5000) | 39 |
| Rucoflex S ® - 1074-30 (Mₙ = 3500) | 8 |

Blend 4b′ giving the adhesive material B4b′:

| | |
|---|---|
| Capa 2077 ® (Mₙ = 750) | 37 |
| Rucoflex XS ® - 6012 P-22 (Mₙ = 5000) | 32.5 |
| Rucoflex S ® - 1074-30 (Mₙ = 3500) | 6.5 |
| Orevac 9305* | 16 |

*vinyl acetate content: 26-30% by weight; ASTM D1238 melt flow index (190° C./2.16 kg): 150-210 g/10 min; ASTM D1505 density: 0.950 g/cm³; DSC melting point: 67° C.

Blend 4c giving the adhesive material B4c:

| | |
|---|---|
| Capa ® 2054 (Mₙ = 550) | 50 |
| Rucoflex XS ® - 6012 P-22 (Mₙ = 5000) | 43 |
| Xenol DP ® 9B/1339 (Mₙ = 3500) | 7 |

In general, these adhesive materials according to the invention may be prepared in the following manner:

Introduced into a jacketed stainless steel reactor fitted with a stirring system in order to work at low pressure, with a temperature probe and with a valve, allowing the introduction of raw materials under a controlled dry nitrogen atmosphere, are the amorphous polyester followed by the crystalline polyester and the polylactone.

The polyester blend is homogenized at a temperature of 100° C. under a pressure of 1 Pa of dry nitrogen, the various additives are introduced and the resulting mixture is maintained with stirring for one hour under the above conditions. The residual water content, which must be below 0.01% by weight, is checked. The isocyanate is added over ten minutes while controlling the temperature rise of the mixture up to 170° C. The mixture is maintained under a 50 Pa dry nitrogen atmosphere at 140-180° C. for forty-five minutes. The mixture is immediately conditioned by cooling below 100° C. over less than ten minutes.

In the case of a terpolymer being used in the adhesive polymer material, the manufacturer of said material is carried out in the following manner: at the end of curing, an amount of thermoplastic polymer of polyolefin type (predehydrated terpolymer) is added into the prepolymer formed. The temperature is kept constant for 10 minutes until the polymer has melted and homogenized. The peripheral speed of the stirring member is 20 m/s in order to ensure rapid and perfect blending of the two materials. The conditioning is carried out in the same way as previously.

The layer of adhesive polymer material has a thickness of 50 to 300 μm. The solids content of the adhesive polymer material is practically 100% (absence of solvent). As indicated above, at least one of the substrates is made of a polyether block copolymer.

As examples of polyether block copolymers, mention may be made of copolymers having polyester blocks and polyether blocks (also called polyetheresters), copolymers having polyurethane blocks and polyether blocks (also called TPUs, the abbreviation for thermoplastic polyurethanes) and copolymers having polyether blocks and polyamide blocks (also called PEBAs according to the IUPAC).

With regard to the polyetheresters, these are copolymers having polyester blocks and polyether blocks. They consist of soft polyether blocks, which are the residues of polyetherdiols, and hard segments (polyester blocks), which result from the reaction of at least one dicarboxylic acid with at least one chain-extender short diol unit. The polyester blocks and the polyether blocks are linked by ester links resulting from the reaction of the acid functional groups of the acid with the OH functional groups of the polyetherdiol. The chain-extender short diol may be chosen from the group consisting of neopentyl glycol, cyclohexanedimethanol and aliphatic glycols of formula HO(CH₂)ₙOH in which n is an integer ranging from 2 to 10. Advantageously, the diacids are aromatic dicarboxylic acids having from 8 to 14 carbon atoms. Up to 50 mol % of the aromatic dicarboxylic acid may be replaced with at least one other aromatic dicarboxylic acid having from 8 to 14 carbon atoms and/or up to 20 mol % may be replaced with an aliphatic dicarboxylic acid having from 2 to 12 carbon atoms.

As examples of aromatic dicarboxylic acids, mention may be made of terephthalic acid, isophthalic acid, dibenzoic acid, naphthalene dicarboxylic acid, 4,4′-diphenylenedicarboxylic acid, bis(p-carboxyphenyl)methane acid, ethylene-bis(p-benzoic) acid, 1,4-tetramethylene-bis(p-oxybenzoic) acid, ethylene-bis(para-oxybenzoic) acid, 1,3-trimethylene-bis(p-oxybenzoic) acid. As examples of glycols, mention may be made of ethylene glycol, 1,3-trimethylene glycol, 1,4-tetramethylene glycol, 1,6-hexamethylene glycol, 1,3-propylene glycol, 1,8-octamethylene glycol, 1,10-decamethylene glycol and 1,4-cyclohexylene dimethanol. The copolymers having polyester blocks and polyether blocks are for example copolymers having polyether units derived from polyether diols, such as polyethylene glycol (PEG), polypropylene glycol (PPG) or polytetramethylene glycol (PTMG), dicarboxylic acid units such as terephthalic acid, and glycol (ethane diol) or 1,4-butanediol units. The chainlinking of the polyethers and the diacids forms the soft segments, whereas the chainlinking of the glycol or the butanediol with diacids forms the hard segments of the copolyetherester. Such copolyetheresters are described in the patents EP 402 883 and EP 405 227. These polyetheresters are thermoplastic elastomers. They may contain plasticizers.

With regard to the TPUs, these consist of soft polyether blocks, which are residues of polyetherdiols, and hard blocks (polyurethanes), which result from the reaction of at least one diisocyanate with at least one short diol. The chain-extender short diol may be chosen from the glycols mentioned above in the description of the polyetheresters. The polyurethane blocks and polyether blocks are linked by links resulting from the reaction of the isocyanate functional groups with the OH functional groups of the polyetherdiol.

Mention may also be made of polyesterurethanes, for example those comprising diisocyanate units, units derived from amorphous polyesterdiols and units derived from a chain-extender short diol. They may contain plasticizers.

The copolymers having polyether blocks and polyamide blocks (PEBA) result from the copolycondensation of polyamide blocks having reactive end groups with polyether blocks having reactive end groups, such as, among others:
1) polyamide blocks having diamine chain ends with polyoxyalkylene blocks having dicarboxylic chain ends;
2) polyamide blocks having dicarboxylic chain ends with polyoxyalkylene blocks having diamine chain ends obtained by cyanoethylation and hydrogenation of aliphatic alpha, omega-dihydroxylated polyoxyalkylene blocks, called polyetherdiols; and
3) polyamide blocks having dicarboxylic chain ends with polyetherdiols, the products obtained being, in this particular case, polyetheresteramides. The copolymers of the invention are advantageously of this type.

The polyamide blocks having dicarboxylic chain ends derive for example from the condensation of polyamide precursors in the presence of a chain-stopper dicarboxylic acid.

The polyamide blocks having diamine chain ends derive for example from the condensation of polyamide precursors in the presence of a chain-stopper diamine.

The polymers having polyether blocks and polyamide blocks may also include randomly distributed units. These polymers may be prepared by the simultaneous reaction of polyether and of the polyamide block precursors.

For example, a polyetherdiol, polyamide precursors and a chain-stopper diacid may be made to react together. What is obtained is a polymer having essentially polyether blocks, polyamide blocks of very variable length, but also the various reactants that have reacted randomly, which are distributed randomly along the polymer chain.

A polyetherdiamine, polyamide precursors and a chain-stopper diacid may also be made to react together. What is obtained is a polymer having essentially polyether blocks, polyamide blocks of very variable length, but also the various reactants that have reacted randomly, which are distributed randomly along the polymer chain.

Advantageously, three types of polyamide blocks may be used. According to a first type, the polyamide blocks derive from the condensation of a dicarboxylic acid and a diamine.

According to a second type, the polyamide blocks result from the condensation of one or more alpha, omega-aminocarboxylic acids and/or of one or more lactams having 6 to 12 carbon atoms in the presence of a dicarboxylic acid having 4 to 12 carbon atoms or of a diamine.

According to a third type, the polyamide blocks result from the condensation of at least one alpha, omega-aminocarboxylic acid (or a lactam), at least one diamine and at least one dicarboxylic acid. According to a variant of this third type, the polyamide blocks result from the condensation of at least two alpha, omega-aminocarboxylic acids or of at least two lactams having 6 to 12 carbon atoms or of a lactam and of an aminocarboxylic acid not having the same number of carbon atoms possibly in the presence of a chain stopper.

Advantageously, the polyamide blocks of the second type are nylon-12 polyamide blocks or nylon-6 polyamide blocks.

As examples of polyamide blocks of the third type, mention may be made of the following:
PA 6,6/Pip.10/12 in which
6,6 denotes hexamethylene adipamide (hexamethylenediamine condensed with adipic acid) units;
Pip.10 denotes units resulting from the condensation of piperazine and of sebacic acid;
12 denotes units resulting from the condensation of lauryllactam. The proportions by weight are respectively 25 to 35/20 to 30/20 to 30/the total being 80, and advantageously 30 to 35/22 to 27/22 to 27, the total being 80. For example, the proportions 32/24/24 result in a melting point of 122 to 137° C.
6,6/6,10/11/12 in which
6,6 denotes hexamethylenediamine condensed with adipic acid;
6,10 denotes hexamethylenediamine condensed with sebacic acid;
11 denotes units resulting from the condensation of aminoundecanoic acid;
12 denotes units resulting from the condensation of lauryllactam.

The proportions by weight are respectively 10 to 20/15 to 25/10 to 20/15 to 25, the total being 70 and advantageously 12 to 16/18 to 25/12 to 16/18 to 25, the total being 70. For example, the proportions 14/21/14/21 result in a melting point of 119 to 131° C.

The polyamide blocks are obtained in the presence of a diacid or of a chain-stopper diamine, if it is desired to have polyamide blocks with acid or amine end groups. If the precursors already contain a diacid or a diamine, it is sufficient for example to use it in excess.

By way of example of aliphatic alpha, omega-aminocarboxylic acids, mention may be made of aminocaproic, 7-aminoheptanoic, 11-aminoundecanoic and 12-aminododecanoic acids.

As examples of lactams, mention may be made of caprolactam, oenantholactam and lauryllactam.

As examples of aliphatic diamines, mention may be made of hexamethylenediamine, dodecamethylenediamine and trimethylhexamethylenediamine.

As examples of cycloaliphatic diacids, mention may be made of 1,4-cyclohexyldicarboxylic acid.

As examples of aliphatic diacids, mention may be made of butanedioic, adipic, azelaic, suberic, sebacic and dodecanedicarboxylic acids, dimerized fatty acids (these dimerized fatty acids preferably have a dimer content of at least 98%; preferably they are hydrogenated; they are sold under the brand name PRIPOL from Unichema or under the brand name EMPOL from Henkel) and α,ω-polyoxyalkylene diacids.

As examples of aromatic diacids, mention may be made of terephthalic (T) and isophthalic (I) acids.

The cycloaliphatic diamines may be the isomers of bis(4-aminocyclohexyl)methane (BACM), bis(3-methyl-4-aminocyclohexyl)methane (BMACM), 2,2-bis(3-methyl-4-aminocyclohexyl)propane (BMACP) and para-aminodicyclohexylmethane (PACM). Other diamines commonly used may be isophoronediamine (IPDA), 2,6-bis(aminomethyl)norbornane (BAMN) and piperazine.

The polyether blocks may represent 5 to 85% by weight of the copolymer having polyamide and polyether blocks. The polyether blocks consist of alkylene oxide units. These units may for example be ethylene oxide units, propylene oxide units or tetrahydrofuran units (which lead to polytetramethylene glycol chain linkages). Thus, PEG blocks, that is to say those consisting of ethylene oxide units, PPG blocks, that is to say those consisting of propylene oxide units, poly(trimethylene ether glycol) units (such copolymers with poly(trimethylene ether) blocks are described in patent U.S. Pat. No. 6,590,065) and PTMG blocks, that is to say those consisting of tetramethylene glycol units, also called polytetrahydrofuran, are used. Advantageously, PEG blocks or blocks obtained by the oxyethylation of bisphenols, such as for example bisphenol A, are used. The latter products are described in patent EP 613 919.

The polyether blocks may also consist of ethoxylated primary amines. It is also advantageous to use these blocks. As examples of ethoxylated primary amines, mention may be made of the products of formula:

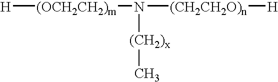

in which m and n are between 1 and 20 and x is between 8 and 18. These products are commercially available under the brand name NORAMOX® from CECA and under the brand name GENAMIN® from Clariant.

The amount of polyether blocks in these copolymers having polyether blocks and polyamide blocks is advantageously 10 to 70% and preferably 35 to 60% by weight of the copolymer.

The polyetherdiol blocks are either used as such and copolycondensed with polyamide blocks having carboxylic end groups, or they are aminated in order to be converted into polyether diamines and condensed with polyamide blocks having carboxylic end groups. They may also be blended with polyamide precursors and a diacid chain stopper in order to make polymers having polyether blocks and polyamide blocks having randomly distributed units.

The number-average molecular weight M̅ₙ of the polyamide blocks is between 500 and 10 000 and preferably between 500 and 4000, except for the polyamide blocks of the second type. The molecular weight M̅ₙ of the polyether blocks is between 100 and 6000 and preferably between 200 and 3000.

These polymers having polyether blocks and polyamide blocks, whether they derive from the copolycondensation of polyamide blocks and polyethers prepared beforehand, or from a one-step reaction, have, for example, an intrinsic viscosity measured in metacresol at 25° C. for an initial concentration of 0.8 g/100 ml of between 0.8 and 2.5.

With regard to the preparation of the copolymers having polyether blocks and polyamide blocks, these may be prepared by any means allowing the polyamide blocks and the polyether blocks to be linked together. In practice, essentially two processes are used, one called a two-step process and the other a one-step process. In the two-step process, the polyamide blocks are firstly produced and then, in a second step, the polyamide blocks and the polyether blocks are linked together. In the one-step process, the polyamide precursors, the chain stopper and the polyether are mixed together. What is therefore obtained is a polymer having essentially polyether blocks, polyamide blocks of very variable length, but also the various reactants that have reacted randomly, which are distributed randomly along the polymer chain. Regardless of whether the process is a one-step or a two-step process, it is advantageous to operate in the presence of a catalyst. It is possible to use the catalysts described in the patents U.S. Pat. No. 4,331,786, U.S. Pat. No. 4,115,475, U.S. Pat. No. 4,195,015, U.S. Pat. No. 4,839,441, U.S. Pat. No. 4,864,014, U.S. Pat. No. 4,230,838 and U.S. Pat. No. 4,332,920, WO 04 037898, EP 1 262 527, EP 1 270 211, EP 1 136 512, EP 1 046 675, EP 1 057 870, EP 1 155 065, EP 506 495 and EP 504 058. In the one-step process, polyamide blocks are also produced—this is why it was stated at the beginning of this paragraph that these copolymers could be prepared by any means for linking the polyamide blocks and polyether blocks together.

Usual polymers: those having PA blocks made of PA-6, made of PA-12 or made of PA 6/6,6; and those having PTMG blocks.

The other of the substrates may be of the same nature, that is to say made of a copolymer having polyether blocks, or of a different nature.

Among materials of a different nature suitable for the other of the substrates, mention may be made of polymers and copolymers, such as polyolefins, polyamines, polyamides, polyesters, polyethers, polyester ethers, polyimides, polyamideimides, polycarbonates, phenolic resins, crosslinked or uncrosslinked polyurethanes, especially foams, polyimides, ethylene/vinyl acetate copolymers, natural or synthetic elastomers, such as polybutadienes, polyisoprenes, styrene-butadiene-styrene (SBS), styrene-butadiene-acrylonitrile (SBN), polyacrylonitriles, natural or synthetic fabrics, especially fabrics consisting of organic polymer fibres, such as fabrics made of polypropylene, polyethylene, polyester, polyvinyl alcohol, polyvinyl acetate, polyvinyl chloride or polyaramid fibres, fabrics made of glass fibres and carbon fibres, and also materials such as leather, paper and cardboard. All these materials may also be in foam form when this is possible.

As examples of laminates, mention may be made of:
copolymer having polyether blocks and polyamide blocks/adhesive/TPU;
copolymer having polyether blocks and polyamide blocks/adhesive/leather;
copolymer having polyether blocks and polyamide blocks/adhesive/polyurethane foam;
copolymer having polyether blocks and polyamide blocks/adhesive/TPU foam;
copolymer having polyether blocks and polyamide blocks/adhesive/rubber; and
copolymer having polyether blocks and polyamide blocks/adhesive/polyolefin nonwoven.

The substrates generally have a thickness of 0.4 to 5 mm.

The present invention also relates to a process for manufacturing the laminate described above, which comprises the following steps:
(a) the adhesive polymer material is applied to one surface of at least one of the two substrates, preferably only one surface of one of the substrates, and better still of the single substrate made of a PEBA copolymer;
(b) the surface having the adhesive polymer material of one of the substrates is brought into contact with a surface, which may or may not have the adhesive polymer material, of the other of the substrates in order to form an assembly comprising the two substrates with the adhesive polymer material between them;
(c) the assembly is placed in a press in a humid atmosphere, and pressed; and
(d) the press is opened and the laminated product recovered.

The pressure applied during the pressing step is from 1 to 15 kg/cm², preferably 3 to 10 kg/cm², and the temperature is from 20° C. to 150° C.

The humid atmosphere is preferably air with a relative humidity HR≧5%, preferably HR≧10% and better still HR≧20%.

Preferably, the process also includes, prior to step a) defined above, a step in which the surfaces of the substrates to be coated with adhesive are cleaned using at least one organic solvent, such as methyl ethyl ketone (MEK), acetone and ethyl acetate.

The presses used in the process of the invention are conventional presses used in the field of manufacturing laminates.

The examples below illustrate the present invention. In the examples, unless other indicated, all the percentages and parts are expressed by weight.

Below, Pebax 55-1 and Pebax 70-1 denote copolymers having polyether blocks and polyamide blocks. They consist of alternating blocks of PTMG and PA-12.

TABLE IV

PEBAX ®

| | 55-1 | 70-1 |
|---|---|---|
| MFI (g/10 mn) | 3/10 | 3/7 |
| Min. viscosity | 1.43 | 1.33 |
| Max. viscosity | 1.58 | 1.48 |
| d | 1.01 | 1.02 |
| DSC (° C.) | 159 | 172 |
| Cryst. Temp. (° C.) | 110 | 121 |
| 23° C./65% H₂O abs. (%) | 0.5 | 0.6 |
| Vicat (1 daN) (° C.) | 144 | 165 |
| Flex. mod. (MPa) | 170 | 430 |
| Tensile mod. (MPa) | 160 | 383 |
| Shore D hardness | 55 | 69 |
| 70° C. compression set (%) | 20 | 5 |
| 0.46 MPa HDT (° C.) | 66 | 99 |

### Comparative Laminates C1, C′2 and C″2.

The process for producing the Comparative laminates is the following:
the surfaces of the substrates to be coated with adhesive are cleaned at room temperature;
a primer layer is applied to the cleaned surfaces using a brush;
the primer layer is dried;
a bicomponent adhesive is applied to the primer layer using a brush;
the adhesive layer is dried;
the adhesive-coated substrates are brought into contact with each other;
the assembly is pressed in air; and
the final laminate is recovered.

The various parameters relating to Comparative laminates C1, C′2 and C″2 are given in Table V below.

TABLE V

| | Substrate | | | | | | | | |
|---|---|---|---|---|---|---|---|---|---|
| COMPARATIVE | Substrate | Substrate | Surface | Primer | | Adhesive | | Pressing | |
| LAMINATES | 1 nature | 2 nature | cleaning | Nature | Drying | Nature | Drying | Pressure | Time |
| C1 | Pebax ® | Pebax ® | 5 s with | Nanpao ® | 65° C. oven | Nanpao ® | 60° C. oven | 7-10 | 10-12 |
| | 55-1 | 55-1 | MEK at room | 2101 + | for 3.5 | NP-57 ® + | for 4 | kg/cm² | seconds |
| | | | temperature | 4.5% by | minutes | 3.5% by | minutes | | |
| | | | | weight of | | weight | | | |
| | | | | RFE | | Nanpao CL- | | | |
| | | | | | | 16 | | | |
| C′2 | Pebax ® | Pebax ® | 5 s with | Dongsung | 60° C. oven | Dongsung | 50° C. oven | 7-10 | 10-12 |
| | 55-1 | 55-1 | MEK at room | D-Ply 167 ® + | for 3.5 | W-01 + 5% | for 3 | kg/cm² | seconds |
| C″2 | Pebax ® | Pebax ® | temperature | 4.5% by | minutes | by weight | minutes | | |
| | 70-1 | 70-1 | | weight of | | of | | | |
| | | | | RFE | | Dongsung | | | |
| | | | | | | ARF 40 ® | | | |

Description of the components:
Nanpao 2101 ® (solids content - 30 min/150° C. = 0.07 wt %;
RFE ® (Bayer) (solids content - 30 min/150° C. = 26.9 wt %;
Nanpao NP-57 ® (solids content - 30 min/150° C. = 49.8 wt %;
Nanpao CL-16 ® (solids content - 30 min/150° C. = 80 wt %;
Dongsung D-Ply ® 167 (solids content - 30 min/150° C. = 10.3 wt %;
Dongsung W-01 ® (solids content - 30 min/150° C. = 46.9 wt %;
Dongsung ARF-40 ® (solids content - 30 min/150° C. = 83.5 wt %.
Geometry of substrates 1 and 2:
Width: 15 mm;
Length: 100 mm;
Thickness: 1 mm.

The primer layer has a dry thickness of 1 to 4 μm and the adhesive layer has a dry thickness of 30 to 50 μm.

Peel tests were carried out on the comparative laminates C1, C′2 and C″2 according to the ISO11339 standard at a speed of 100 mm/min. The results of these tests are given in Table VI.

TABLE VI

| Comparative | | |
|---|---|---|
| laminate | Test No. | Average peel force (DaN/cm) |
| C1 | 1 | 6.39 |
| | 2 | 2.66 |
| | 3 | 8.09 |
| | 4 | 8.19 |
| C′2 | 1 | 3.34 |
| | 2 | 3.37 |
| | 3 | 2.53 |
| | 4 | 1.10 |
| | 5 | 1.05 |
| | 6 | 6.52 |
| C″2 | 1 | 7.93 |
| | 2 | 2.76 |
| | 3 | 7.47 |
| | 4 | 8.19 |
| | 5 | 5.72 |

The results show that, although suitable results are obtained with Pebax® 55-1 of low hardness, the results with Pebax® 70-1 of high hardness are very scattered and in general unacceptable.

### EXAMPLES 1 TO 4

Laminates according to the invention were produced as follows:
the surfaces of the two substrates to be coated with adhesive were cleaned with an organic solvent;
the adhesive polymer material according to the invention was applied to only one of the surfaces to be coated;
the two substrates were brought into contact with each other; and
the assembly was pressed, in air, for one minute at a pressure of 4 bar and at a controlled temperature, so as to control the creep, in the present case a temperature of 20 to 120° C.

The thickness of the adhesive polymer material layer was 150 to 300 μm.

The parameters relating to the laminates according to the invention Nos. 1 to 4 are given in Table VII.

TABLE VII

| | | Substrates | | |
|---|---|---|---|---|
| | | Substrate | Substrate | Adhesive |
| Laminate | Surface | 1 | 2 | polymer |
| No. | cleaning | Nature | Nature | material |
| 1 | 5 seconds | Pebax ® | Pebax ® | A |
| | with MEK at | 55-1 | 55-1 | |
| 2 | room | Pebax ® | Pebax ® | A |
| | temperature | 70-1 | 70-1 | |
| 3 | | Pebax ® | Pebax ® | B4b |
| | | 55-1 | 55-1 | |
| 4 | | Pebax ® | Pebax ® | B4b |
| | | 70-1 | 70-1 | |
| 5 | | Pebax ® | Pebax ® | B4b′ |
| | | 55-1 | 55-1 | |
| 6 | | Pebax ® | Pebax ® | B4b′ |
| | | 55-1 | 55-1 | |

### Geometric Parameters of Substrates 1 and 2 for Laminates 1 to 4 According to the Invention:

Length: 100 mm;
Width: 15 mm;
Thickness: 1 mm.

### Geometric Parameters of Substrates 1 and 2 for Laminates 5 and 6 According to the Invention:

Length: 100 mm;
Width: 25 mm;
Thickness: 1 mm.

Series of laminates according to the invention Nos 1 to 4 were subjected to peel tests. The results are given in Table VIII below.

TABLE VIII

| Laminate No. | Test No. | Average peel force (kg/cm) |
|---|---|---|
| 1 | 1 | 7.57 |
| | 2 | 5.02 |
| | 3 | 4.55 |
| | 4 | 4.10 |
| | 5 | 5.52 |
| 2 | 1 | 4.64 |
| | 2 | 4.96 |
| | 3 | 4.96 |
| | 4 | 5.16 |
| | 5 | 4.11 |
| 3 | 1 | 9.85 |
| | 2 | 12.38 |
| | 3 | 10.18 |
| | 4 | 9.41 |
| | 5 | 8.94 |
| | 6 | 8.55 |
| 4 | 1 | 7.59 |
| | 2 | 5.25 |
| | 3 | 9.07 |
| | 4 | 6.54 |
| | 5 | 6.52 |
| | 6 | 6.04 |

The results show that, regardless of the hardness of the Pebax® used, the values of the peel strength obtained are constantly high, much better than 3 daN/cm.

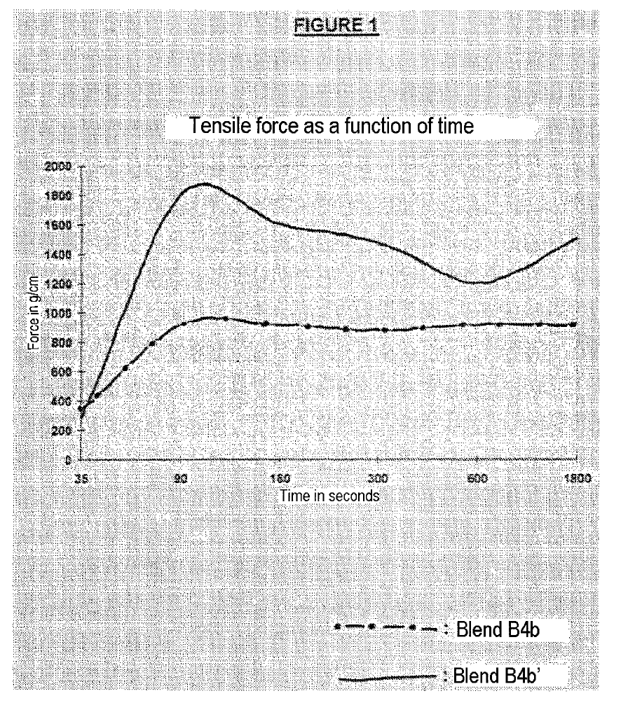

Laminates 5 and 6 according to the invention were subjected to peel tests function of time according to the ISO 11339 standard: as a rate 100 mm/min. The results of these test rates are given in the graph shown in FIG. 1. Note, the peel force increases when an adhesivity agent of the terpolymer type (ethylene/vinyl acetate/MAH) is added to the adhesive polymer material.

1. A laminated product comprising a first substrate and a second substrate that adhere to each other only by means of a cured and crosslinked layer of an adhesive polymer material containing no organic solvent, wherein:
(a) the polymer material of either or both of the first and second substrates is a polyether block copolymer; and
(b) the adhesive polymer material is a moisture-crosslinkable hot-melt adhesive based on a polyurethane prepolymer containing free isocyanate (—N═C═O) functional groups or on a blend of polyurethane prepolymers containing free isocyanate (—N═C═O) functional groups.

2. The laminated product as claimed in claim 1, wherein the polyurethane prepolymer or the blend of polyurethane prepolymers represents 75% by weight or more of the total weight of the adhesive polymer material.

3. The laminated product as claimed in claim 1, wherein the polyurethane prepolymer has a content of free isocyanate functional groups representing 0.5 to 25% by weight, relative to the total weight of the prepolymer.

4. The laminated product as claimed in claim 1, wherein the polyurethane prepolymer has a number-average molecular weight (Mₙ) of 500 to 500 000.

5. The laminated product as claimed in claim 1, wherein the polyurethane prepolymer is the product resulting from the reaction of at least one hydroxylated polyester and/or of at least one hydroxylated polyether with at least one polyisocyanate.

6. The laminated product as claimed in claim 5, wherein the hydroxylated polyesters and the hydroxylated polyethers are selected from the group consisting of polyesterdiols, polyestertriols, polyetherdiols, and polyethertriols, and the polyisocyanates are chosen from diisocyanates.

7. The laminated product as claimed in claim 5, wherein the diisocyanate is chosen from 4,4′-diphenylmethane diisocyanate (MDI), 1,6-hexamethylene diisocyanate (HDI), isophorone diisocyanate (IPDI) and toluene diisocyanate (TDI) and mixtures thereof.

8. The laminated product as claimed in claim 5, wherein the polyurethane prepolymer is the product resulting from the reaction of 55 to 95% by weight of at least one hydroxylated polyester and/or hydroxylated polyether with 45 to 5% of at least one polyisocyanate.

9. The laminated product as claimed in claim 1, wherein the layer of adhesive polymer material has a thickness of 50 to 300 μm.

10. The laminated product as claimed in claim 1, wherein the copolymer having polyether blocks is chosen from copolymers having polyester blocks and polyether blocks, copolymers having polyurethane blocks and polyether blocks and copolymers having polyamide blocks and polyether blocks (PEBA).

11. The product as claimed in claim 1, wherein the material of the substrates, other than the copolymer having polyether blocks, is selected from the group of polymers and copolymers consisting of, polyolefins, polyamines, polyamides, polyesters, polyethers, polyester ethers, polyimides, polyamideimides, polycarbonates, phenolic resins, crosslinked or uncrosslinked polyurethanes, foamed polyurethanes, polyimides, ethylene/vinyl acetate copolymers, natural or synthetic elastomers, polybutadienes, polyisoprenes, styrene-butadiene-styrene (SBS), styrene-butadiene-acrylonitrile (SBN), polyacrylonitriles, natural or synthetic fabrics, fabrics consisting of organic polymer fibres; fabrics made of polypropylene, polyethylene, polyester, polyvinyl alcohol, polyvinyl acetate, polyvinyl chloride or polyaramid fibres; fabrics made of glass fibres and carbon fibres, leather, paper and cardboard, polyester ethers, polyetherimides and polyamideimides.

12. The laminated product as claimed in claim 1, comprising a shoe sole, or a sports shoe sole.

13. The laminated product as claimed in claim 1, wherein the adhesive polymer material further comprises an adhesivity agent representing from 0 to 20% of the total weight of the adhesive material.

14. The laminated product as claimed in claim 13, wherein the adhesivity agent is chosen from:
Terpene resins, dicyclopentadiene derivatives, alpha-pinene and beta-pinene, dipentene, natural esterified or modified colophony, optionally modified with phenolic resins;
Copolymers resulting from the reaction:
(i) of an ethylene/unsaturated epoxide copolymer, said unsaturated epoxide being grafted or copolymerized, with
(ii) a carboxylic acid of formula R1-COOH or derivatives thereof, in which R1 denotes an alkyl, cycloalkyl or aromatic radical comprising at least one hydroxyl function,
Polyolefins, selected from the group comprising:
copolymers: ethylene/vinyl acetate ethylene/alkyl, (meth)acrylate, ethylene/methyl acrylate, ethylene/methyl methacrylate, ethylene/ethyl acrylate, ethylene/butyl acrylate and ethylene/2-ethylhexyl acrylate,
terpolymers: ethylene/vinyl acetate/maleic anhydride, ethylene/acrylic ester/maleic anhydride, ethylene/acrylic ester/glycidyl methacrylate,
grafted polyolefins: MAH-grafted LDPE, MAH-grafted LLDPE, MAH-grafted HDPE, MAH-grafted PP, MAH-grafted ethylene/vinyl acetate or MAH-grafted ethylene/alkyl (meth)acrylate, MAH-grafted ethylene/methyl acrylate, terpolymers having reactive groups of the maleic anhydride (abbreviated MAH) type or of the glycidyl methacrylate (abbreviated GMA) type, and grafted polyolefins having reactive groups of the maleic anhydride (abbreviated MAH) type.

15. The laminated product as claimed in claim 14, wherein the copolymers resulting from the reaction (i) of an ethylene/unsaturated epoxide copolymer, said unsaturated epoxide being grafted or copolymerized, with (ii) a carboxylic acid of formula R1-COOH or derivatives thereof, in which R1 denotes an alkyl, cycloalkyl or aromatic radical comprising at least one hydroxyl function, comprise:
60 to 90% ethylene by weight;
40 to 200 meq OH.

16. The laminated product as claimed in claim 14, wherein the ethylene/unsaturated epoxide copolymer engaged in the reaction (i) is an ethylene/glycidyl (meth)acrylate copolymer or an ethylene/alkyl (meth)acrylate/glycidyl (meth)acrylate copolymer.

17. A process for manufacturing the laminate of claim 1, comprising the following steps:
(a) applying an adhesive polymer material to one surface of at least one of the first and second substrates;
(b) bringing the surface having the adhesive polymer material of one of the substrates into contact with a surface, which may or may not have adhesive polymer material, of the other of the substrates in order to form an assembly comprising the first and second substrates with the adhesive polymer material between them;
(c) placing the assembly in a press in a humid atmosphere, and pressing; and
(d) opening the press and recovering the laminated product.

18. The process as claimed in claim 17, wherein, during the pressing step, the applied pressure is from 1 to 15 kg/cm², the temperature is from 20° C. to 150° C. and the humid atmosphere, has a humidity HR≧5%,

19. The process as claimed in claim 17, further comprising, prior to step (a) applying the adhesive polymer material, in which the surfaces of the substrates to be bonded with adhesive are cleaned using an organic solvent or a mixture of organic solvents.

20. (canceled)

21. The laminated product of claim 3, wherein the polyurethane prepolymer has a content of free isocyanate functional groups representing 2 to 10% by weight, relative to the total weight of the prepolymer.

22. The laminated product as claimed in claim 4 wherein the polyurethane prepolymer has a number-average molecular weight (Mₙ) of 5000 to 150 000.

23. The laminated product as claimed in claim 8 wherein the polyurethane prepolymer is the product resulting from the reaction of 65 to 85%, by weight of at least one hydroxylated polyester and/or hydroxylated polyether 35 to 15%, of at least one polyisocyanate.
